(19) United States
(12) Patent Application Publication
(10) Pub. No.: US 2025/0103581 A1
(43) Pub. Date: Mar. 27, 2025

(54) SYSTEMS AND METHODS FOR CLASSIFICATION AND IDENTIFICATION OF NON-COMPLIANT ELEMENTS

(71) Applicant: Walmart Apollo, LLC, Bentonville, AR (US)

(72) Inventors: Bin Liu, Rogers, AR (US); Akash Chandrakar, Bentonville, AR (US); Kathryn Leoma Bunch, Springdale, AR (US); Valerie Lynne Buxton, Lansing, MI (US); Saritha Geetha Sasi, Rogers, AR (US)

(21) Appl. No.: 18/473,504

(22) Filed: Sep. 25, 2023

(51) Int. Cl. G06F 16/23

(52) U.S. Cl. CPC G06F 16/2365

(57) ABSTRACT

Systems and methods for updating a database including compliance verification are disclosed. A database update including at least one addition of or modification to a data record in a database is received. A compliance status is generated by providing at least a portion of the database update to a multilayer monitoring process configured to implement at least a keyword similarity process and a trained classification model. When the compliance status indicates an approved database update, the addition of or modification to the data record in the database is executed.

### TECHNICAL FIELD

This application relates generally to classification of electronic catalog elements, and more particularly, to classification of electronic catalog items for compliance verification.

### BACKGROUND

Certain network platforms enable third-party users (e.g., individuals, corporations, etc.) to provide content for incorporation into the network platform that is presented through a unified network interface page. The unified network interface page is associated with a first-party network operator that may provide content for incorporation into the network platform. Network platforms may include e-commerce platforms and provided content may include items and/or services available for purchase through the e-commerce platform.

Network operators may be required to comply with certain laws and regulations limiting the types of content, e.g., products, services, etc., that may be included in a network platform. For example, in the context of e-commerce platforms, a network provider may be restricted from providing certain classes of items (e.g., weapons, illegal drugs, etc.) for sale. Current systems rely on rules-based systems for identifying content that violates compliance requirements. However, such rules-based systems may be circumvented, either intentionally or accidentally, based on modifications to the provided content.

### SUMMARY

In various embodiments, a system including a non-transitory memory and a processor communicatively coupled to the non-transitory memory is disclosed. The processor is configured to read a set of instructions to receive a database update including at least one addition of or modification to a data record in a database, generate a compliance status by providing at least a portion of the database update to a multilayer monitoring process configured to implement at least a keyword similarity process and a trained classification model, and when the compliance status indicates an approved database update, execute the addition of or modification to the data record in the database.

In various embodiments, a computer-implemented method is disclosed. The computer-implemented method includes steps of receiving a database update including at least one modification of a data record in a database, determining when the at least one modification corresponds to one of a predetermined set of data elements of the data record, in response to determining the least one modification corresponds to one of the predetermined set of data elements, generating a compliance status by a multilayer monitoring process configured to implement at least a keyword similarity process and a trained classification model based on at least the at least one modification, and when the compliance status indicates an approved database update, executing the modification to the data record in the database.

In various embodiments, a non-transitory computer-readable medium having instructions stored thereon is disclosed. The instructions, when executed by at least one processor, cause at least one device to perform operations including receiving a database update including at least one addition of or modification to a data record in a database, implementing a keyword similarity process configured to determine a similarity between at least one textual element of the database update and each of a set of predetermined terms, in response to the keyword similarity process determining the similarity between the at least one textual element and each of the set of predetermined terms is below a predetermined threshold, implementing a trained classification model configured to classify the database update as one of an approved or rejected, and, in response to the trained classification model classifying the database update as approved, executing the addition of or modification to the data record in the database.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide database updates with compliance verification, in accordance with some embodiments;

FIG. 2 illustrates a computer system configured to implement one or more processes, in accordance with some embodiments;

FIG. 3 is a flowchart illustrating a database update method including compliance verification, in accordance with some embodiments;

FIG. 4 is a process flow illustrating various steps of the database update method of FIG. 3, in accordance with some embodiments.

FIG. 5 is a flowchart illustrating a multilayer monitoring process, in accordance with some embodiments;

FIG. 6 is a flowchart illustrating a keyword similarity process, in accordance with some embodiments;

FIG. 7 illustrates a trained language model, in accordance with some embodiments;

FIG. 8 illustrates a trained image recognition model, in accordance with some embodiments;

FIG. 9 illustrates a process flow including a keyword similarity process and a trained classification model, in accordance with some embodiments;

FIG. 10 illustrates an artificial neural network, in accordance with some embodiments;

FIG. 11 illustrates a tree-based artificial neural network, in accordance with some embodiments;

FIG. 12 illustrates a deep neural network (DNN), in accordance with some embodiments;

FIG. 13 is a flowchart illustrating a training method for generating a trained machine learning model, in accordance with some embodiments; and

FIG. 14 is a process flow illustrating various steps of the training method of FIG. 13, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for content compliance verification. In various embodiments, a content element or listing is received for inclusion in a network catalog associated with a network platform. For example, in some embodiments, an item for inclusion in an e-commerce catalog associated with an e-commerce platform may be received. Elements of the content, such as a text based elements (e.g., title, description, etc.), image-based elements, etc. are utilized for compliance verification. A first filtering process may be implemented to apply one or more rules-based verifications. For example, in some embodiments, a keyword matching process may be used to identify content having text-based elements including exact matches to certain terms, such as negative (e.g., rejected) terms, positive (e.g., approved) terms, etc. A content submission may be approved, rejected, or provided for further review based on the output of the first filtering process. A second filtering process may be implemented utilizing a trained filtering model. The trained filtering model may be configured to apply a distance matching process for identifying content elements similar to blocked content elements. A content submission may be approved or rejected based on the output of the second filtering process.

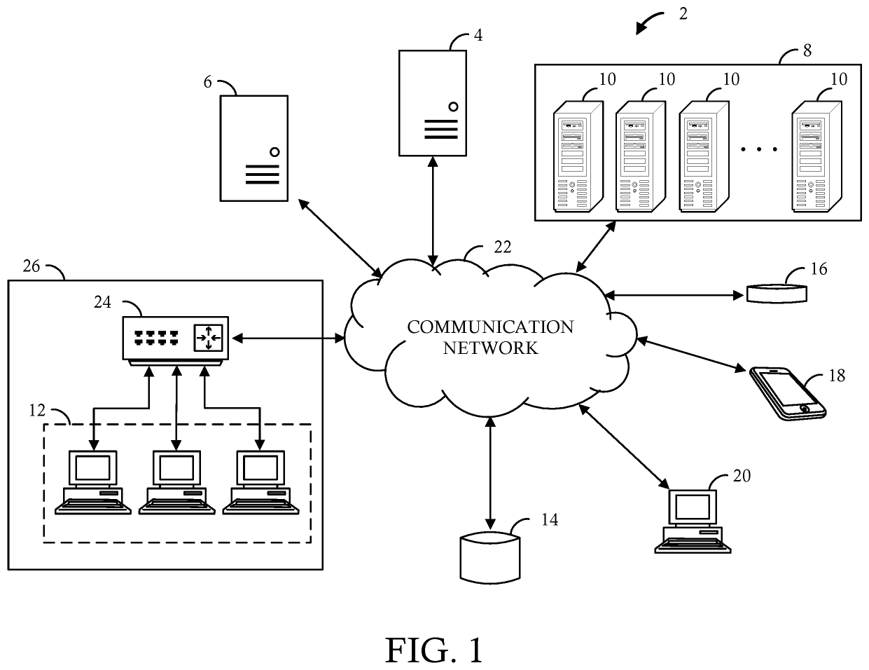

FIG. 1 illustrates a network environment 2 configured to provide compliance verification, in accordance with some embodiments. The network environment 2 includes a plurality of devices or systems configured to communicate over one or more network channels, illustrated as a network cloud 22. For example, in various embodiments, the network environment 2 may include, but is not limited to, a compliance verification computing device 4, a web server 6, a cloud-based engine 8 including one or more processing devices 10, workstation(s) 12, a database 14, and/or one or more user computing devices 16, 18, 20 operatively coupled over the network 22. The compliance verification computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the compliance verification computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the compliance verification computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the compliance verification computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the compliance verification computing device 4, for example. The workstation(s) 12 may communicate with the compliance verification computing device 4 over the communication network 22. The workstation(s) 12 may send data to, and receive data from, the compliance verification computing device 4. For example, the workstation(s) 12 may transmit data related to tracked operations performed at the physical location 26 to compliance verification computing device 4.

Although FIG. 1 illustrates three user computing devices 16, 18, 20, the network environment 2 may include any number of user computing devices 16, 18, 20. Similarly, the network environment 2 may include any number of the compliance verification computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the compliance verification computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, interacting with interface elements presented via the website, for example, in the search results, uploading interface or content elements for inclusion in the website, etc. The website may capture these activities as user session data, and transmit the user session data to the compliance verification computing device 4 over the communication network 22.

In some embodiments, the compliance verification computing device 4 may execute one or more models, processes, or algorithms, such as a machine learning model, deep learning model, statistical model, etc., to perform one or more compliance verification processes. The compliance verification computing device 4 may transmit a compliance response to the web server 6 over the communication network 22, and the web server 6 may display interface elements associated with the compliance response on the website to the user. For example, the web server 6 may display interface elements configured to enable upload of one or more content elements and may display interface elements associated with the compliance response as part of and/or in response to a content upload process.

In some embodiments, the web server 6 transmits a content upload request to the compliance verification computing device 4. The content upload request may include a request to add one or more new content items to a catalog associated with the website (e.g., associated with a network environment). The compliance verification computing device 4 is configured to implement a compliance verification process, such as a compliance verification process including at least a first, rules-based filtering process and a second, machine learning-based filtering process. The compliance verification process determines whether the new content elements comply with one or more rules, regulations, laws, and/or platform requirements. For example, in some embodiments, the one or more new content items are items to be included in an e-commerce catalog and the compliance verification process determines whether each new item may be included in a corresponding e-commerce platform (e.g., that each item complies with all applicable rules, regulations, laws, etc. governing operation of the e-commerce platform).

The compliance verification computing device 4 is further operable to communicate with the database 14 over the communication network 22. For example, the compliance verification computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the compliance verification computing device 4, in some embodiments, the database 14 may be a local storage device, such as a hard drive, a non-volatile memory, or a USB stick. The compliance verification computing device 4 may store interaction data received from the web server 6 in the database 14. The compliance verification computing device 4 may also receive from the web server 6 user session data identifying events associated with browsing sessions, and may store the user session data in the database 14.

In some embodiments, the compliance verification computing device 4 generates training data for a plurality of models (e.g., machine learning models, deep learning models, statistical models, algorithms, etc.) based on catalog data, historical interaction/upload data, etc. The compliance verification computing device 4 and/or one or more of the processing devices 10 may train one or more models based on corresponding training data. The compliance verification computing device 4 may store the models in a database, such as in the database 14 (e.g., a cloud storage database).

The models, when executed by the compliance verification computing device 4, allow the compliance verification computing device 4 to implement one or more compliance verification processes. For example, the compliance verification computing device 4 may obtain one or more models from the database 14. The compliance verification computing device 4 may then receive, in real-time from the web server 6, a compliance verification request. In response to receiving the compliance verification request, the compliance verification computing device 4 may execute one or more models to determine a distance match between one or more elements of a new content item and known, prohibited content items.

In some embodiments, the compliance verification computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, compliance verification computing device 4 may generate a compliance response indicating approval or rejection of the one or more new content items.

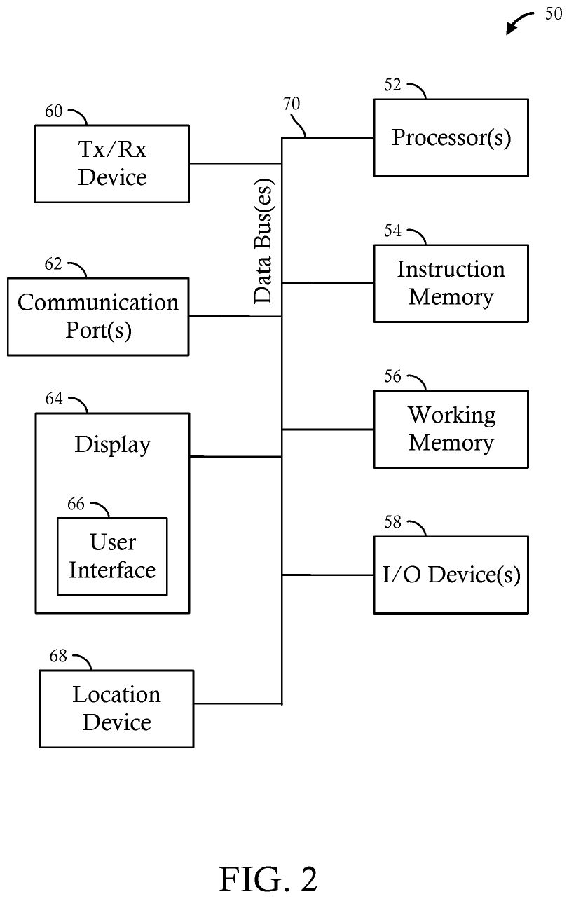

FIG. 2 illustrates a block diagram of a computing device 50, in accordance with some embodiments. In some embodiments, each of the compliance verification computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™. Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for content compliance verification, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT. EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with compliance verification processes. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to the a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

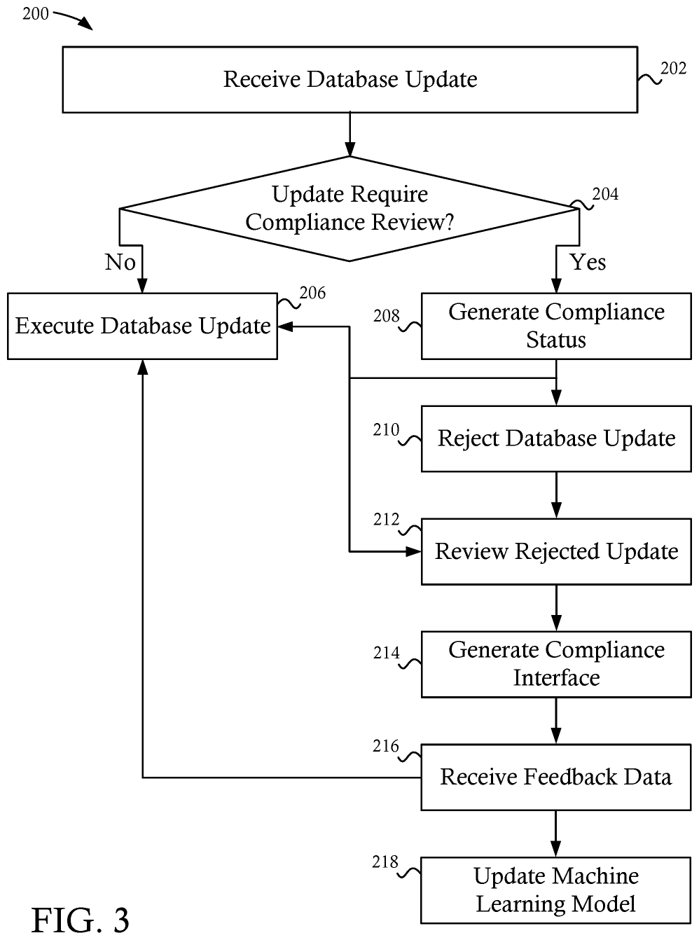

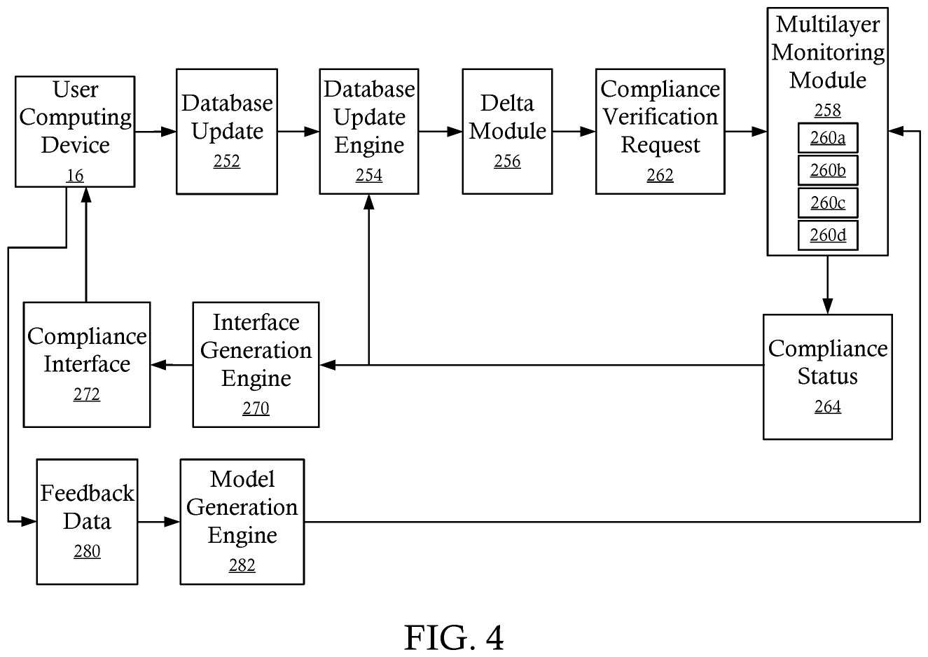

FIG. 3 is a flowchart illustrating a database update method 200 including compliance verification, in accordance with some embodiments. FIG. 4 is a process flow 250 illustrating various steps of the database update method 200, in accordance with some embodiments. At step 202, a database update 252 is received. The database update 252 may include a new data element to be added to a database and/or a change or modification for at least one existing data record. In some embodiments, the database update 252 includes an update to a network catalog associated with a network interface, such as, for example, an addition and/or modification of an item in an e-commerce catalog associated with an e-commerce interface. In some embodiments, the database update 252 may include one or more updated and/or preexisting elements related to a changed (e.g., updated, added) data record. The one or more elements may include, but are not limited to, text-based elements such as a title, description, parameters, etc., image-based elements, metadata, etc. In some embodiments, the database update 252 may include data related only to modified elements of a data record. In some embodiments, the database update 252 is received by a database update engine 254.

At step 204, a determination is made whether the database update 252 constitutes a change requiring compliance verification. For example, the addition of one or more new content items to an e-commerce catalog may be a change requiring compliance verification. As another example, a change of one or more elements of an existing data record may be a change requiring compliance verification, such as a change to a title, image, description, etc. of an existing data record. In contrast, a change not requiring compliance verification may include a change to one or more elements of a data record that does not implicate compliance rules, such as a price element, a shipping fulfillment element, an inventory element, etc. associated with an e-commerce catalog data record. It will be appreciated that a change requiring a compliance verification constitutes a change that may implicate one or more compliance requirements, such as restrictions on the sale of certain goods and/or services, reporting requirements, tracking requirements, etc.

In some embodiments, the determination at step 204 is performed by a delta module 256 configured to determine a delta, or difference, between an existing version of a catalog item (if any) and the database update 252. For example, in some embodiments, the database update 252 identifies a catalog item. The delta module 256 may obtain a current version of the catalog item from a network catalog and compare the existing version with the database update 252 to determine a difference, e.g., delta, between the two versions. As another example, in some embodiments, the delta module 256 may be configured to identify a prior version of the catalog item based on one or more attributes of existing catalog items and the catalog update, such as, for example, an item identifier (e.g., SKU, barcode, UPC, etc.), title, description, brand, user, etc. The delta module 256 may be configured to identify the database update 252 as requiring additional compliance verification when a change is identified in one or more predetermined portions of a content item, such as a title, description, image, etc. In some embodiments, failure to identify an existing version of a data record corresponding to the database update 252 indicates a new data record to be added, which requires additional compliance verification.

When the determination at step 204 indicates the database update 252 does not require additional compliance verification, the database update method 200 proceeds to step 206 and the database update 252 is executed. When the determination at step 204 indicates the database update 252 requires additional compliance verification, the database update method 200 proceeds to step 208 for further processing.

At step 208, a compliance status 264 indicating whether the database update 252 is an approved (e.g., compliant) or rejected (e.g., non-compliant) update is generated. In some embodiments, a multilayer monitoring process generates the compliance status 264. The multilayer monitoring process may be implemented by, for example, a multilayer monitoring module 258. The multilayer monitoring process includes at least two monitoring subprocesses, or layers, configured to collectively determine a compliance status 264. In some embodiments, the multilayer monitoring process includes one or more of a text-based subprocess, a rules-based subprocess, an image-based subprocess, a machine learning-based subprocess, and/or any other suitable monitoring subprocess.

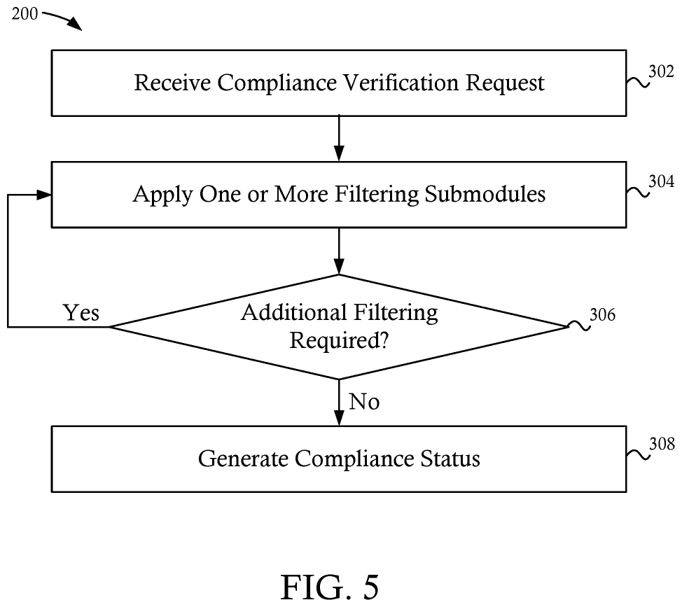

FIG. 5 is a flowchart illustrating a multilayer monitoring process 300, in accordance with some embodiments. At step 302, a compliance verification request 262 is received. The compliance verification request 262 may be generated by, for example, a delta module 256 in response to determining that a database update 252 requires additional compliance verification, a database update engine 254 in response to receiving a database update 252, and/or in response to any other suitable trigger. The compliance verification request 262 may include at least a portion of the database update 252. In some embodiments, the compliance verification request 262 is received by a multilayer monitoring module 258.

At step 304, one or more filtering submodules 260a-260d (collectively “filtering submodules 260”) are applied to classify the compliance verification request 262 as one of a compliant (e.g., allowed) update or non-compliant (e.g., blocked or rejected) update. In some embodiments, each of the filtering submodules 260 may be configured to implement a filtering process, such as, for example, a keyword similarity process, a text similarity process, an image similarity process, a classification process, and/or any other suitable filtering process. Two or more filtering submodules (and the corresponding filtering processes) may be executed in series and/or parallel. For example, a keyword similarity submodule 260a and a text similarity submodule 260b may be executed in parallel for a received compliance verification request 262. As another example, a keyword similarity submodule 260a and a text similarity submodule 260b may be executed simultaneously, e.g., in parallel, for a received compliance verification request 262. Subsequently, and based on an output of the keyword similarity process, a classification submodule 260d may be executed in series with the keyword similarity submodule 260a. The classification submodule 260d may be executed in parallel with and/or subsequent to the text similarity submodule 260b. It will be appreciated that any combination of series and/or parallel filtering submodules 260 (and the corresponding filtering processes) may be applied to classify a database update 252.

In some embodiments, a keyword similarity submodule 260a implements a keyword similarity process configured to identify predetermined terms and/or variants of predetermined terms in one or more elements of a database update 252. The keyword similarity process may be configured to identify positive or compliance terms (e.g., terms that indicate non-compliance or potential non-compliance) and/or negative or excluded terms (e.g., common terms that are excluded to avoid false positives). Excluded terms may include, but are not limited to, common terms such as “the,” “a,” “and,” etc. In some embodiments, the keyword similarity process can be configured to apply multiple keyword matching subprocesses, such as a direct match process and a distance matching process.

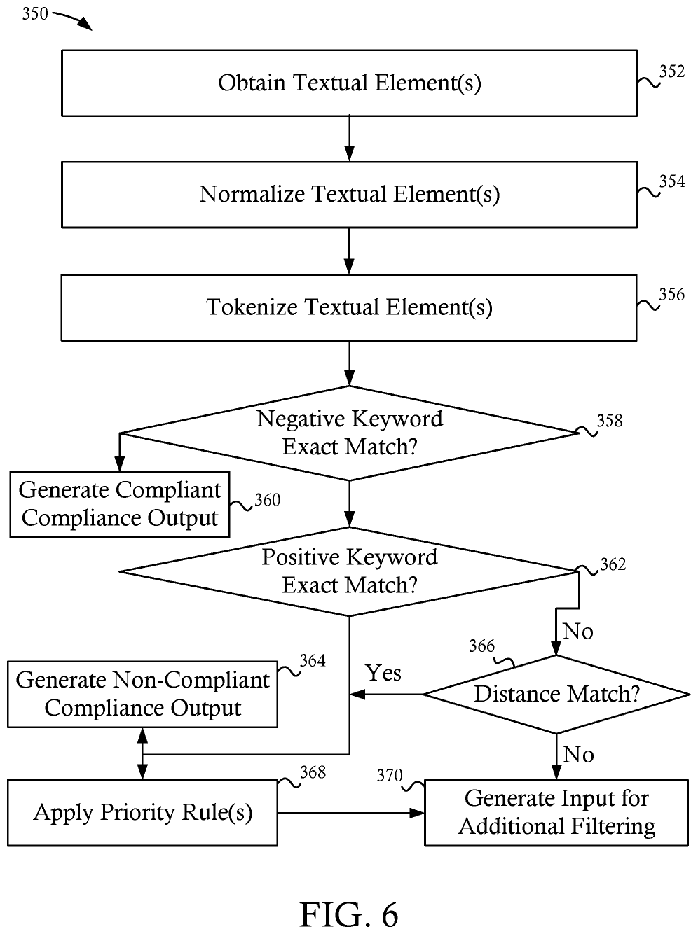

In some embodiments, a keyword similarity process includes a direct match comparison configured to identify direct textual matches between a predetermined term and a term in the database update 252 and distance matching comparison configured to identify a term in the database update 252 that are variants of a predetermined term. FIG. 6 is a flowchart illustrating a keyword similarity process 350, in accordance with some embodiments. At step 352, a textual element, such as a title, description, feature, etc. is obtained (e.g., extracted) from the database update 252. The textual element may be included in a compliance verification request 262, obtained from a storage mechanism storing the database update 252 (e.g., a queue or temporary memory location storing all pending database updates), and/or from any other suitable source. In some embodiments, multiple textual elements are obtained for the database update 252.

At step 354, each of the extracted textual elements is normalized. For example, each textual element may be cleaned to remove certain characters (e.g., removing non-letter and/or non-number characters), modified to include a predetermined set of characters (e.g., replacing all uppercase letter characters with lowercase variants), etc. It will be appreciated that any suitable normalization process and/or scheme may be applied to a received textual element.

At step 356, each normalized textual element is tokenized. Tokenization includes conversion of each textual element into a unique token, e.g., vector, representation that retains essential information about the textual element. The textual elements may be tokenized using any suitable tokenization process, such as, for example, a word2vec model, a char2vec model, etc. In some embodiments, a pretrained tokenization model may be generated from a training dataset including corresponding textual elements (e.g., titles, descriptions, etc.) of data records in an associated database, such as corresponding item elements in an e-commerce catalog. Each textual element may be tokenized into one or more tokens, such as, for example, one or more tokens representing each word, character, known phrase, etc. in the textual element.

At step 358, a negative keyword match process is performed between the textual element and a set of predetermined negative keywords. Negative keywords include words or phrases indicating that a textual element, and the associated database update 252, does not fall within a category of concern (e.g., does not require a compliance review). In some embodiments, when a negative keyword match is identified, e.g., when at least one term in the extracted textual element matches one of the predetermined negative keywords, the keyword similarity process 350 proceeds to step 360 and a compliance status 264 indicating a compliant update is generated. When no match is identified, e.g., when the textual element does not contain one of the predetermined negative keywords, the keyword similarity process 350 proceeds to step 362.

In some embodiments, generation of the compliance status 264 at step 360 prevents and/or stops execution of any additional filtering submodules 260a-260d and/or filtering subprocesses. For example, a match between a textual element and at least one of the predetermined negative keywords indicates that the underlying database update 252 is not subject to compliance review and therefore no further processing is required. As one non-limiting example, in the context of an e-commerce interface, a database update 252 may include a title element including a negative keyword indicating that the element falls within a category that does not require compliance review, such as an article of clothing or a book. For example, a title element extracted from a database update 252 may include negative terms such as “t-shirt” or “paperback,” indicating that the type of item related to the database update, e.g., a t-shirt or paperback book, are not subject to compliance review (as compared to an item falling within a reviewable category such as weapons or controlled substances).

In some embodiments, the negative keyword comparison includes an exact match comparison. For example, in some embodiments, one or more tokens generated from a textual element, e.g., word tokens for each word in the textual element, are compared to one or more tokens representative of a set of predetermined negative keywords to identify exact token matches. As another example, in some embodiments, direct text matches (e.g., library match) may be performed between normalized textual elements and the set of predetermined negative keywords. It will be appreciated that any suitable direct match process may be implemented to identify textual elements having directly matching terms with a set of predetermined negative keywords.

At step 362, a positive keyword exact match process is performed between the textual element and a set of predetermined positive keywords. Positive keywords include words or phrases indicating that a textual element, and the associated database update 252, include a non-compliant database update and/or probably include a non-compliant database update. In some embodiments, when a positive keyword match is identified, e.g., when at least one term in the extracted textual element matches one of the predetermined positive keywords, the keyword similarity process 350 proceeds to step 364 and a compliance status 264 indicating a non-compliant update is generated. When no match is identified, e.g., when the textual element does not contain an exact match with one of the predetermined positive keywords, the keyword similarity process 350 proceeds to step 366.

In some embodiments, the exact match process is performed by comparing the one or more tokens generated from a textual element, e.g., word tokens for each word in the textual element, to one or more tokens representative of a set of predetermined positive keywords to identify exact token matches. As another example, in some embodiments, direct text-element matches (e.g., library match) may be performed between normalized textual elements and the set of predetermined keywords. It will be appreciated that any suitable direct match process may be implemented to identify textual elements having directly matching terms with a set of predetermined positive keywords.

In some embodiments, an exact match between a textual element or a subcomponent (e.g., word, phrase, etc.) thereof and a positive keyword indicates a non-compliant catalog update. For example, in the context of an e-commerce interface, database updates may be restricted from including a certain type of item, such as weapons, as such items are restricted from being included in an e-commerce catalog. Words and/or phrases identifying one or more types of weapon, such as “brass knuckles,” may be included in the set of predetermined positive keywords. A direct match between the phrase “brass knuckles” and the textual element extracted from a database update 252 indicates that the database update 252 includes (or likely includes) a restricted weapon, e.g., brass knuckles. When a direct match is identified, the database update 252 is classified as being within a restricted category or containing restricted content (e.g., corresponding to a restricted or prohibited item that should not be added to the network catalog) and the database update 252 is classified as a non-compliant update. When an exact match is identified, the keyword similarity process 350 may proceed to step 364 and generate a compliance status 264 indicating a non-compliant update or may proceed to optional step 368 for further processing, as discussed in greater detail below.

If a positive keyword exact match is not identified at step 360, the keyword similarity process 350 proceeds to step 366 and implements a positive keyword distance matching subprocess. In some embodiments, the positive distance matching subprocess includes a fuzzy match process using a Jaro-Winkler (JR) distance. For example, a distance (e.g., match percentage) between one or more tokens associated with a database update 252 and one or more tokens representative of the set of predetermined positive keywords may be determined. A match is identified when the distance between the tokens is within a certain threshold, e.g., when the similarity of the compared tokens is above a predetermined percentage. For example, in some embodiments, a match between one or more tokens representative of a textual element extracted from a database update 252 and one or more tokens representative of a predetermined positive term is identified when the similarity is above 85%, above 90%, above 95%, etc. It will be appreciated that any suitable threshold may be selected to optimize detection of non-compliant updates while avoiding false positive identifications. Further, although embodiments are discussed herein including a positive keyword distance match, it will be appreciated that a negative keyword distance match may additionally and/or alternatively be implemented, for example, as part of step 358 and/or step 366.

When a positive keyword distance match is identified at step 366, the keyword similarity process 350 may proceed to step 364 and generate a compliance status 264 indicating a non-compliant update or may proceed to optional step 368 for further processing, as discussed in greater detail below. When no match is identified at step 366, the keyword similarity process 350 may proceed to step 370, discussed below. The distance matching comparison subprocess is configured to identify modified versions of predetermined terms. For example, in some embodiments, a predetermined positive term may include “Brass Knuckles” and a database update 252 may include a modified or manipulated version of the predetermined positive term, such as “Br@ss Knuckles,” “Br@ss_knuckles,” etc. Keyword similarity processes 350 incorporating a distance match subprocess are configured to identify intentional and/or unintentional modifications to predetermined terms without the need to define a library including every potential variant of a term to be excluded (which is both resource intensive and ultimately unworkable given the potential number of variants that may be created for a term).

In some embodiments, the distance matching subprocess categorizes the textual element, and by extension the underlying database update 252, into one of a predetermined number of categories. For example, in some embodiments, the distance matching subprocess classifies the textual element in a category associated a most-likely positive keyword match. The category of the most-likely positive keyword match may be selected even when the match is below the predetermined threshold applied to determine a distance match. For example, if a textual element contains three terms having highest probability distance matches of 70%, 60%, and 45%, respectively, and the predetermined similarity threshold for a distance match is 90%, the distance matching subprocess will not identify a distance match between any of the predetermined positive keywords and the textual element and the textual element will be classified in a category associated with the positive keyword having a 70% match.

In some embodiments, the category of the textual element and/or the database update 252 may be determined from data included with the database update 252. For example, the database update 252 may include a category identification. As another example, in some embodiments, the category of the textual element and/or the database update 252 may be determined from one or more data elements and/or metadata elements included with the database update 252. Although specific embodiments are discussed herein, it will be appreciated that any suitable process may be implemented to generate a categorization of a textual element and/or a database update 252.

At optional step 368, one or more priority rules may be applied to determine an output for one or more matched terms. For example, a set of predetermined positive terms may be divided into two or more tiers, such as a first tier and a second tier. A first tier may include terms that are strictly prohibited and/or of high concern and a second tier may include terms that may indicate a non-compliant update but are of lesser concern as compared to the first tier of terms. For example, in the context of an e-commerce interface, a first tier of positive terms may include terms related to strictly prohibited and/or regulated items that may not be included in an e-commerce catalog, such as “drugs,” “illegal,” etc. and a second tier of positive terms may include terms related to potentially prohibited and/or regulated items, such as “nunchakus” which may be associated with/indicate a restricted weapon or may be associated with a non-restricted item, such as a toy set including toy nunchakus.

In some embodiments, one or more priority rules may be applied to determine an output of the keyword similarity process 350 based on a tier of the positive term that was matched. For example, in some embodiments, when a textual element has a match (e.g., exact match or distance match) with at least one first tier positive term, a compliance status 264 indicating a non-compliant catalog update that should be rejected may be generated and when a textual element has a match (e.g., exact match or distance match) with a second tier predetermined term, the extracted textual element and/or the database update 252 may be provided for further review (as discussed below with respect to step 370). It will be appreciated that any suitable set of rules may be applied to determine an output based on a tier of the positive term match identified by an exact and/or distance match subprocess.

In some embodiments, when neither an exact or distance match is identified, or when the priority rules applied at step 368 indicate further processing is required, the keyword similarity process 350 proceeds to step 370 and generates an input for one or more additional filtering processes. For example, in some embodiments, the generated input includes a category of the textual element and/or the database update 252, one or more of the tokens generated from the textual element, one or more probabilities generated by the distance matching subprocess, and/or any other suitable output. As discussed in greater detail below, the output of the keyword similarity process 350 may be provided as an input to one or more other filtering processes, such as a classification submodule 260d. Alternatively, in some embodiments, when neither an exact or distance match is identified, the keyword similarity process 350 completes without generating an output.

In some embodiments, a text similarity submodule 260b may be configured to implement a text similarity process to identify textual elements of a database update 252 that are similar to textual elements of known and/or prior non-compliant records or items. A non-compliant database update may, intentionally or unintentionally, include terms or phrases that, individually, are not included in a set of predetermined terms used by the keyword similarity submodule 260a but that indicate a non-compliant item when considered as a whole. For example, a prior attempt to add a non-compliant item to an e-commerce catalog may have included a textual title or description that intentionally obfuscates the item to avoid compliance checks but that is nevertheless recognizable as the non-compliant item by users of the e-commerce platform, such as an attempt to add brass knuckles to an e-commerce catalog where the title and/or description of the brass knuckles indicates the item is a “brass paperweight with finger holes.” A database update 252 may be a subsequent attempt to add the non-compliant item to the e-commerce catalog using similar language, such as “finger ring paperweight brass.” The text similarity submodule 260b is configured to identify a database update 252 that includes one or more words or phrases having a high similarity to words or phrases associated with known non-compliant items, as such similarity may indicate a non-compliant or likely non-compliant update.

In some embodiments, the text similarity submodule 260b generates an output indicating compliance or non-compliance of the database update 252. For example, where a text string, e.g., a phrase, word, etc., in the database update 252 has a similarity above a predetermined threshold with respect to a text string associated with a known non-compliant record, an output may be generated indicating a non-compliant database update. Similarly, where a text string in a database update 252 has a similarity below a first predetermined threshold but above a second predetermined threshold with respect to a text string associated with a known non-compliant record, an output may be generated indicating a likely non-compliant catalog update. Alternatively, where a text string in a database update 252 has a similarity below one or more predetermined thresholds, an output may be generated indicating a compliant or likely compliant catalog update.

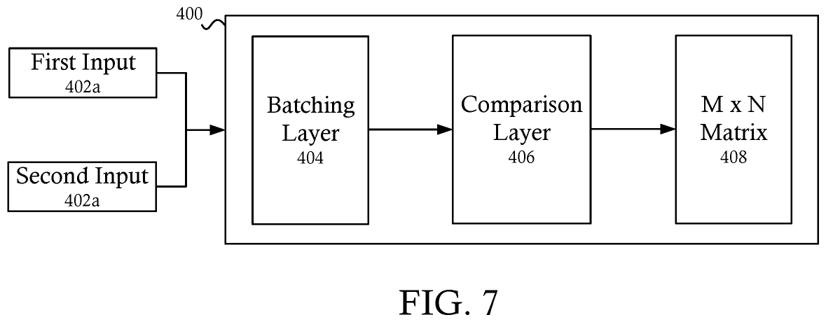

In some embodiments, the text similarity submodule 260b is configured to implement a text similarity process by implementing one or more trained machine learning models, such as a trained language model 400 as illustrated in FIG. 7. A trained language model 400 may be configured to apply batching, normalized dot product generation, and/or any other suitable techniques to identify textual elements (e.g., words, phrases, etc.) having a similarity above (or equal to) a predetermined threshold with words or phrases associated with known and/or prior non-compliant items. In some embodiments, the trained language model 400 may be generated from a labeled training dataset including textual elements taken from historically rejected (e.g., non-compliant) items labeled as non-compliant. The training dataset may further include textual elements taken from historically allowed (e.g., compliant) items labeled as compliant.

In the illustrated embodiment, the trained language model 400 is configured to receive a first input 402a including one or more elements of one or more database updates 252, such as, for example, one or more textual elements of database updates received during a predetermined time period (e.g., hourly, daily, weekly, etc.). The trained language model 400 is further configured to receive a second input 402b including one or more elements of historic non-compliant records, such as titles, descriptions, etc. associated with known and/or previously identified non-compliant records or updates. Although specific embodiments are illustrated herein, it will be appreciated that any suitable input set may be received by the trained language model 400.

The trained language model 400 includes a batching layer 404 configured to batch the input sets, such as the first input set including database updates, for efficient processing. Batching may include grouping of database updates that are related to the same and/or similar products, that include the same and/or similar textual elements, and/or any other suitable batching process. In some embodiments, the set of database updates (e.g., the set of n textual elements extracted from one or more database updates 252) are batched exclusive of the set of historic non-compliant records (e.g., the set of m textual elements extracted from one or more historic non-compliant records).

The trained language model 400 includes one or more comparison layers 406, such as one or more normalized dot product layers. The comparison layers 406 are configured to compare each of the n textual elements extracted from one or more database updates 252 to each of the m textual elements extracted from one or more historic non-compliant records. In some embodiments, the comparison layers 406 generate an m×n matrix 408 indicating a similarity value (e.g., percentage) between each of the n textual elements extracted from one or more database updates 252 and each of the m textual elements extracted from one or more historic non-compliant records.

In some embodiments, a compliance determination is generated for each textual element in the first input set 402a based on the m×n matrix 408. For example, for each entry in the m×n matrix 408 having a similarity value above a predetermined threshold (e.g., above a predetermined percentage), an output indicating a non-compliant update may be generated. In some embodiments, the trained language model 400 may output an m×n matrix in which each entry indicates a compliant or non-compliant update based on the similarity value of the m×n matrix 408, although it will be appreciated that any suitable format may be used for generating an output of the language model 400. Although specific embodiments are discussed herein, it will be appreciated that any suitable language model framework may be used to generate a trained language model. For example, the trained language model 400 may include one or more of a recurrent neural network (RNN), a large language model (LLM), a word n-gram model, a skip-gram model, a maximum entropy model, etc.

In some embodiments, the text similarity submodule 260b generates an input for use by one or more additional filtering processes. For example, in some embodiments, the input includes a category of the textual element and/or the database update 252. For example, in some embodiments, each of the historic non-compliant records includes a category associated therewith. The text similarity submodule 260b may be configured to generate an output including a category associated with the historic non-compliant record having the highest percentage (e.g., probability) match with the input textual element, e.g., the category of the historic non-compliant record having a highest similarity with the database update 252. As discussed in greater detail below, the output of the text similarity submodule 260b may be provided as an input to one or more other filtering processes, such as a classification submodule 260d.

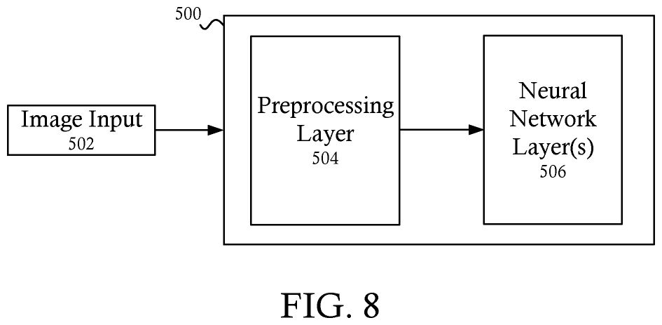

In some embodiments, an image similarity submodule 260c is configured to implement an image similarity process to identify a database update 252 including image elements (e.g., item images, brand images, etc.) identical or similar to image elements associated with known and/or previously identified non-compliant records or updates. An image similarity submodule 260c may be configured to implement an image similarity process by implementing one or more trained machine learning models, such as a trained image recognition model 500 as illustrated in FIG. 8. The trained image recognition model 500 may be configured to apply one or more pre-processing layers 504 to format, normalize, or otherwise process an input image 502 obtained from a database update 252. The pre-processed image is provided to one or more neural network layers 506 configured to identify one or more types or classes of items in the input image 502. In some embodiments, the one or more neural network layers 506 include a deep learning neural network configured to extract features of an input image 502 and classify the input image 502. For example, the neural network layers 506 may be configured to classify an image as containing an image similar to known and/or previously identified images associated with non-compliant records or updates and/or classify an image as containing a non-compliant item or element. The trained image recognition model 500 may be generated from a labeled training dataset including image elements taken from historically blocked items labeled as non-compliant. The training dataset may further include random image elements and/or image elements taken from historically allowed items labeled as compliant.

In some embodiments, the image similarity submodule 260c is configured to generate an output indicating one of a compliant or non-compliant database update. For example, where an image in the database update 252 is similar to an image associated with a known and/or previously identified non-compliant record and/or update and/or has a likelihood of containing a non-compliant item or element above a predetermined threshold, an output may be generated indicating a non-compliant update. Alternatively, where no images in a database update 252 have a similarity and/or a likelihood of containing a non-compliant item above the predetermined threshold, an output may be generated indicating a compliant or likely compliant catalog update. Although specific embodiments are discussed herein, it will be appreciated that any suitable image recognition model framework may be used to generate a trained image recognition model. For example, the trained language model 400 may include one or more of a neural network, a deep learning network, etc.

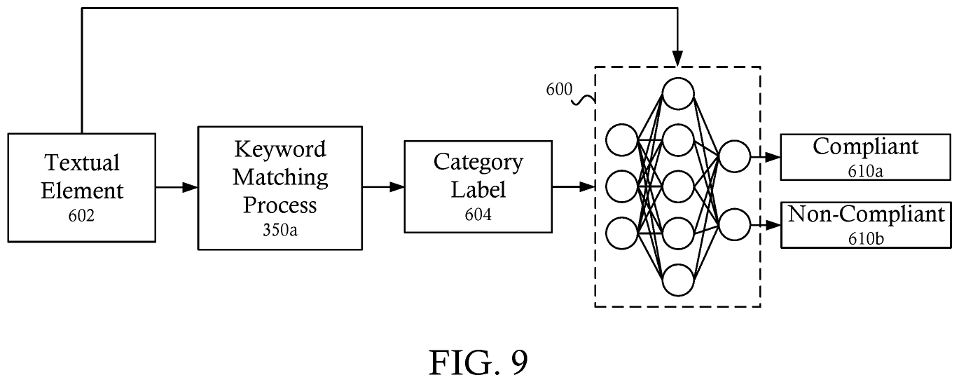

In some embodiments, a classification submodule 260d may be configured to implement a classification process configured to classify a database update 252 as one of a compliant or non-compliant item/update. The classification submodule 260d may execute the classification process by implementing one or more trained machine learning models, such as a trained classification model 600 as illustrated in FIG. 9. A trained classification model may include, for example, a logistic regression model, a decision tree, a random forest, a gradient-boosted tree, a multilayer perceptron, a transformer-based language model (e.g., a bidirectional encoder representations from transformers (BERT) model), etc. In some embodiments, the trained classification model 600 is configured to apply one or more transformer-based language model (LM) layers to classify a database update 252 as one of a compliant (e.g., allowed) update or non-compliant (e.g., blocked) update.

In some embodiments, the trained classification model 600 includes transformer-based LM layers configured to receive inputs including a textual element 602, such as a title or description extracted from a database update 252, and a category label 604 selected for the database update 252. In the illustrated embodiment, the trained classification model 600 includes a binary classification model configured to classify the database update 252 into one of two predetermined compliance labels (e.g., compliance categories), a compliant update 610a (e.g., allowed) or non-compliant update 610b (e.g., blocked). The category label 604 may be generated by one or more prior filtering processes, such as, for example, a keyword matching process 350a. The output of the trained classification model 600 corresponds to the label 610a, 610b. It will be appreciated that the transformer-based LM layers may include a multi-layer transformer-based model including distinct sets of layers, a multi-layer transformed based model including intermingled layers, and/or multiple, separately trained, transformed-based models. In some embodiments, the classification submodule 260d generates a compliance status 264 indicating a compliant update when the trained classification model 600 generates a compliant label 610a and indicating a non-compliant update when the trained classification model 600 generates a non-compliant label 610b.

In some embodiments, the trained classification model 600 includes an attribute extraction layer configured to obtain one or more attributes from a database update 252 and/or a compliance verification request 262. For example, the attribute extraction layer may be configured to obtain one or more predetermined attributes, such as textual attributes, image attributes, meta attributes, etc. The predetermined attributes may be determined during an iterative training process of the trained classification model 600. In some embodiments, a trained classification model is configured to utilize one or more attributes associated with, but not extracted from, a database update 252. For example, in some embodiments, one or more attributes are obtained from a storage repository, e.g. database, associated with the requested database update 252. Attributes associated with, but not extracted from, a database update 252 may include, but are not limited to, a frequency of updates for a corresponding data record, a source of updates for prior modifications to the corresponding data record, etc.

With reference again to FIG. 5, at step 306, a determination is made whether additional filtering is required for the database update 252. In some embodiments, when a filtering process implemented during an iteration of step 304 determines the database update 252 is non-compliant, additional filtering may be skipped and the database update 252 may be provided for additional processing in accordance with a non-compliant update as discussed herein. Alternatively, when the filtering process indicates a compliant update (or does not indicate a non-compliant update), additional filtering may be applied to the database update 252. For example, in some embodiments, during an initial iteration of step 304, a keyword similarity submodule 260a applies a keyword similarity process. If the keyword similarity process identifies a match (e.g., direct match or distance match) with a predetermined term, the database update 252 may be identified as a non-compliant update and no additional filtering processes need to be applied to the database update. Alternatively, if the keyword similarity process does not identify a match, the database update 252 may still be a non-compliant update and additional filtering, such as a text similarity process, an image similarity process, and/or a classification process may be required to identify the non-compliant nature of the database update 252. When it is determined that additional filtering is required, the multilayer monitoring process 300 returns to step 304 and applies a subsequent filtering process. When it is determined that additional filtering is not required, the multilayer monitoring process 300 proceeds to step 308.

Each iteration of step 304 executes one or more selected filtering submodules 260 and the corresponding determination at step 306 may be based on the output of the selected one or more filtering submodules 260 executed during a corresponding iteration of step 304. For example, in some embodiments, during a first iteration of step 304, a first filtering submodule is implemented to execute a first filtering process. The first filtering subprocess approves (e.g., does not reject the database update 252 or does not identify a non-compliant database update). A first iteration of step 306 determines that additional filtering is required, for example, where the first filtering subprocess may not identify all non-compliant updates. The multilayer monitoring process 300 returns to step 304 and a second filtering submodule is implemented to execute a second filtering process. A second iteration of step 306 may determine whether additional filtering is required based only on the output of the second filtering submodule. Alternatively, in some embodiments, the second iteration of step 306 may determine whether additional filtering is required based on the output of each of the first and second filtering submodules.

In some embodiments, it may be determined that additional filtering is not required if the output of any one of the one or more filtering submodules 260 implemented during a corresponding iteration of step 304 indicate a non-compliant update. For example, as discussed above with respect to FIG. 6, a keyword similarity submodule 260a may generate an output indicating a match with one or more predetermined terms associated with non-compliant items. Similarly, and as discussed above, each of the text similarity submodule 260b, the image similarity submodule 260c, and/or the classification submodule 260d may generate an output indicating a non-compliant database update based on the output of a corresponding trained model. In some embodiments, when an output is generated by any one of the one or more implemented filtering submodules 260 indicating a non-compliant output, the multilayer monitoring process 300 proceeds to step 308. Alternatively, when the output of each of the one or more filtering submodules 260 implemented during an iteration of step 304 indicates a compliant (or potentially compliant) update (e.g., each filtering submodule 260 does not reject the database update 252), additional filtering processes may be applied to the database update 252. In some embodiments, when all available and/or applicable filtering submodules 260 have been applied and each generated an output indicating a compliant (e.g., not rejected) update, the multilayer monitoring process 300 may proceed to step 308.

As one non-limiting example, in some embodiments, a keyword similarity submodule 260a may be applied as a first filtering process, e.g., applied during a first iteration of step 304. The keyword similarity submodule 260a generates an output indicating one of a match with at least one predetermined term or no matches with any predetermined terms. When the output of the keyword similarity submodule 260a indicates a match with at least one predetermined term, a first iteration of step 306 determines that no further filtering is required. When the output of the keyword similarity submodule 260a indicates no match, the first iteration of step 306 determines that additional filtering is required, and a second iteration of step 304 is implemented. In some embodiments, a classification submodule 260d is implemented to execute a second filtering process. The classification submodule 260d generates an output indicating one of an approved (e.g., compliant) or rejected (e.g., non-compliant) update. In some embodiments, a second iteration of step 306 determines that no additional filtering is required. For example, the classification submodule 260d may be the final submodule available for implementation and/or may indicate a result that does not require additional filtering.

As another non-limiting example, in some embodiments, a keyword similarity submodule 260a and a text similarity submodule 260b may be implemented in parallel, e.g., may each be implemented during a first iteration of step 304. Each of the keyword similarity submodule 260a and the text similarity submodule 260b may generate an output indicating one of a match or no matches with any predetermined terms or prior non-compliant elements, respectively. In some embodiments, when the output of at least one the keyword similarity submodule 260a or the text similarity submodule 260b indicate a match, a first iteration of step 306 determines that no further filtering is required. Alternatively, when the output of the keyword similarity submodule 260a and the text similarity submodule 260b each indicate no match, the first iteration of step 306 determines that additional filtering is required, and a second iteration of step 304 is implemented. In some embodiments, the determination during the first iteration of step 306 may be based on the output of a selected one of the submodules 260a, 260b implemented during the first iteration of step 304. For example, in some embodiments, first iteration at step 306 may determine that additional filtering is required when the keyword similarity submodule 260a generates a no match output without consideration of the output of the text similarity submodule 260b. In some embodiments, a second iteration of step 304 includes implementation of a classification submodule 260d to execute a third filtering process. The classification submodule 260d generates an output indicating one of an approved (e.g., compliant) or rejected (e.g., non-compliant) update. In some embodiments, a second iteration of step 306 determines that no additional filtering is required. For example, the classification submodule 260d may be the final submodule available for implementation and/or may indicate a result that does not require additional filtering.

As yet another non-limiting example, in some embodiments, each of the available filtering submodules 260 may be implemented serially. For example, during a first iteration of step 304, a keyword similarity submodule 260a may be implemented. When the output of the keyword similarity submodule 260a indicates a match, a first iteration of step 306 determines that no further filtering is required. Alternatively, when the output of the keyword similarity submodule 260a indicates no match, the first iteration of step 306 determines that additional filtering is required, and a second iteration of step 304 is implemented. In some embodiments, a second iteration of step 304 includes implementation of a text similarity submodule 260b. When the output of the text similarity submodule 260b indicates a match, a second iteration of step 306 determines that no further filtering is required. Alternatively, when the output of the text similarity submodule 260b indicates no match, the second iteration of step 306 determines that additional filtering is required, and a third iteration of step 304 is implemented. In some embodiments, a third iteration of step 304 includes implementation of an image similarity submodule 260c. When the output of the image similarity submodule 260c indicates a match, a third iteration of step 306 determines that no further filtering is required. Alternatively, when the output of the image similarity submodule 260c indicates no match, the third iteration of step 306 determines that additional filtering is required, and a fourth iteration of step 304 is implemented. In some embodiments, a fourth iteration of step 304 includes implementation of a classification submodule 260d. The classification submodule 260d may be the final available one of the filtering submodules 260 and the fourth iteration of step 306 determines that no additional filtering is required without considering the output of the classification submodule 260d, as no additional filtering is available.

Although specific embodiments are discussed herein, it will be appreciated that any suitable combination of parallel and/or series implementations of filtering submodules may be utilized during any number of iterations of steps 304 and 306 of the multilayer monitoring process 300. In addition, it will be appreciated that the determination at any given iteration of step 306 may be based on the outputs of one or more of the filtering submodules 260 implemented at a corresponding iteration of step 304.

In some embodiments, the filtering submodules are applied in a manner configured to reduce processing time and/or resource expenditure for each database update 252. For example, in some embodiments, one or more filtering submodules and/or processes, such as a keyword similarity process implemented by a keyword similarity submodule 260a, have a lower resource requirement, for example requiring fewer compute cycles (e.g., less runtime), less memory, etc. as compared to other available filtering submodules and/or processes, such as a classification submodules 260d. Implementation of filtering submodules 260 that have a lower resource requirement prior to implementation of filtering submodules having a higher resource requirement provides an improvement to operation of the computer system itself in processing database updates, as non-compliant database updates identified by the lower resource filtering submodules are not provided to filtering submodules having higher resource requirements and only those database updates that were not rejected (e.g., flagged, identified as non-compliant) by lower resource submodules are provided to higher resource submodules. Because the higher resource submodules are used only for a subset of received database updates 252, the disclosed multilayer monitoring process 300 provides an improvement to operation of a computer through at least reduced resource consumption and faster processing times.

At step 308, the compliance status 264 is generated. In some embodiments, the compliance status 264 includes a binary data element configured to identify a database update 252 as one of a compliant or non-compliant update. When at least one filtering process indicates a non-compliant catalog update, the compliance status indicates a non-compliant and/or potentially non-compliant catalog update. Alternatively, if none of the filtering processes indicate a non-compliant catalog update, the compliance status indicates a compliant catalog update. In some embodiments, the compliance status 264 may include additional data, such as, for example, data indicating which (if any) filtering process rejected the update, the results and/or output of each of the filtering processes, and/or any other suitable information. In some embodiments, the compliance status 264 is provided to one or more additional processes, as discussed in greater detail below.

With reference again to FIGS. 3-4, when the compliance status 264 indicates an approved (e.g., compliant) update, the database update method 200 proceeds to step 206 and the database update 252 is processed. For example, in some embodiments, an existing data record in a data repository is updated to reflect the data provided in the database update 252. As another example, in some embodiments, a new data record in a data repository is created that includes the data element identified in the database update 252. In some embodiments, the database update method 200 proceeds to step 214 simultaneously with and/or subsequent to processing the database update 252. In some embodiments, the database update method 200 ends after implementing the database update 252.

Alternatively, when the compliance status 264 indicates a rejected (e.g., non-compliant, potentially non-compliant) update, the database update method 200 may proceed to one or more of steps 210 or 212. At step 210, the database update 252 is rejected (e.g., not executed). In some embodiments, the database update 252 may be removed from a pending database update queue, added to a database of known non-compliant updates/items and/or previously rejected updates/items, and/or provided for review (as discussed below with respect to step 212). In some embodiments, a rejection notification may be generated and transmitted to a source of the database update 252, e.g., a user computing device 16 that generated the database update 252. In some embodiments, step 210 is omitted and the database update method 200 proceeds directly to step 212 from step 208.

At step 212, a rejected database update 252 (e.g., a database update 252 having a corresponding compliance status 264 indicating a rejection, a database update 252 rejected at step 210, etc.) is provided for review. In some embodiments, the rejected database update 252 is stored in a storage repository associated with rejected database updates. The rejected database update 252 may be stored with data identifying one or more reasons for a rejection, such as, for example, the output of one or more filtering submodules 260 applied to the database update 252. For example, in some embodiments, the database update 252 is stored with the output of any of the filtering submodules 260 that indicated a non-compliant and/or rejected update. As another example, in some embodiments, the database update 252 is stored with the output of any applied filtering submodule 260, including both filtering submodules that indicated an approved (e.g., compliant, not non-compliant, etc.) update and that indicated a rejected (e.g., non-compliant, potentially non-compliant, etc.) update. In some embodiments, and as discussed in greater detail below, a rejected database update 252 may be incorporated into a training dataset used to train one or more machine learning models configured to implement one or more filtering processes.

At step 214, a compliance interface 272 is generated. In some embodiments, the compliance interface 272 is generated by an interface generation engine 270. The compliance interface 272 may include one or more interface elements configured to display the compliance status 264 and/or additional information related to the compliance status 264. In some embodiments, the output of one or more filtering processes applied by the multilayer monitoring module 258 may indicate a non-compliant database update and the generated compliance interface 272 may indicate the associated one or more filtering submodules 260 and outputs that indicated a non-compliant update. For example, where a keyword similarity submodule 260a generates an output indicating a match (e.g., a non-compliant update), the compliance interface 272 may include one or more interface elements displaying the one or more predetermined terms, the similarity percentage, and/or the corresponding portion of the database update 252. As another example, where an image similarity submodule 260c indicated a non-compliant image, the corresponding image from the database update 252 may be displayed with a matching image from a known non-compliant item and/or an interface element identifying the non-compliant item that was detected in the image.

At step 216, feedback data 280 is received via one or more elements presented on the compliance interface 272. In some embodiments, the compliance interface 272 may include one or more interactive interface elements configured to receive an input indicating confirmation of the compliance status 264 or rejection of the compliance status. For example, a database update 252 may be rejected based on a keyword similarity match (e.g., a distance match) with a predetermined keyword. The compliance interface 272 may include an interface element displaying the predetermined keyword and the textual element in the database update 252 that indicated a distance match with the predetermined term. In some instances, a distance match may have been improperly determined. For example, a textual element may include the terms “Brass Kn0cker,” e.g., a misspelling of a brass knocker, which may have resulted in a distance match with the term “Brass Knuckles” due to the similarity of terms and the type (e.g., “0” in place of “o”). A second interface element may be configured to receive an input indicating that the distance match was incorrect (e.g., “Brass Knocker” is not a misspelling of “Brass Knuckles”) and, in some embodiments, may be configured to receive input indicating the correct term match, e.g., “Brass Knocker.” Feedback data 280 may be generated in response to the received input.

As another example, in some embodiments, the database update 252 (e.g., interface element representative of the data record embodied in the database update 252) may be displayed in conjunction with one or more interface elements configured to receive confirmation of the compliance status 264 (e.g., confirmation of a non-compliant status). The compliance interface 272 may be provided via a user computing device and input received confirming and/or rejecting the compliance status 264. In response to the feedback data 280 indicating confirmation of the compliance status 264, the database update 252 and the corresponding compliance status 264 may be added to an updated training dataset for training and/or updating one or more machine learning models, such as the trained language model, trained image recognition model, and/or trained classification model discussed above. In response to the feedback data 280 indicating rejection of the compliance status 264, the compliance status 264 may be changed (e.g., a non-compliant status changed to a compliant status) and the database update 252 processed in response to the updated compliance status 264. The database update 252 and the updated compliance status 264 may further be added to the updated training dataset for training and/or updating one or more machine learning models.

At step 218, an updated machine learning model, such as an updated language model, an updated image recognition model, and/or an updated classification model is generated based on the updated training dataset. The updated machine learning model may be generated by a model generation engine 282 configured to implement one or more training processes to train a new machine learning model and/or refining an existing machine learning model based on the updated training dataset. Training and updating of a machine learning model is discussed in greater detail below.

Identification of non-compliant database updates can be burdensome and time consuming for users, especially where malicious actors are actively attempting to circumvent compliance checks. Typically, database updates are reviewed manually to identify non-compliant updates that cannot be identified through simple, rules-based reviews. The volume of database updates received by a large network interface, such as an e-commerce interface, cannot be reviewed in a realistic and practical fashion. Historically, compliance interfaces include interfaces configured to receive search terms designed to identify non-compliant items based on a manual definition of potential terms or phrases, for example, requiring a user to guess at possible variations of predetermined terms or modified descriptions for non-compliant data records. Such search-based review typically includes repeated searching of variations and manual review of results, requiring users to navigate through several database records to identify even potentially non-compliant data records. Thus, the user frequently has to perform numerous repetitive steps to identify non-compliant data records that have been added or modified in a corresponding database or catalog.

Systems including a compliance interface generated in response to the results of a multilayer monitoring process 300, as disclosed herein, significantly reduce this problem, allowing users to locate potentially non-compliant updates and/or records with fewer, or in some case no, active steps. For example, in some embodiments described herein, a user is automatically presented with a compliance interface that indicates a non-compliant update that includes, or is in the form of, an interactive interface element configured to receive an input. Each compliance interface thus serves as a programmatically selected shortcut to an interface page, allowing a user to bypass the traditional search structure. Beneficially, programmatically identifying potentially non-compliant database updates and presenting a user with input shortcuts to confirm or reject the update classification may improve the speed of the user's operation of the electronic interface. This may be particularly beneficial for databases having extremely large numbers of daily updates and/or modifications, allowing review of larger volumes of data.

It will be appreciated that the database update method 200 as disclosed herein, particularly when implemented for large datasets intended corresponding to network interfaces such as e-commerce interfaces, is only possible with the aid of computer-assisted machine-learning algorithms and techniques, such as the disclosed filtering submodules 260. In some embodiments, machine learning processes including large language models, image recognition models, and/or classification models are used to perform operations that cannot practically be performed by a human, either mentally or with assistance, such as text similarity processes, image similarity processes, and/or classification processes for databases including a high volumes (e.g., thousands, millions, etc.) of updates over short time periods (e.g., hours, days, etc.). It will be appreciated that a variety of machine learning techniques can be used alone or in combination to determine a compliance status and implement additional operations in response to the compliance status.

In some embodiments, systems, and methods for updating a database including compliance verification includes one or more trained language models, image recognition models, and/or classification models. As discussed above, trained language models may include, but are not limited to, one or more of a recurrent neural network (RNN), a large language model (LLM), a word n-gram model, a skip-gram model, a maximum entropy model, etc. Similarly, and as discussed above, trained image recognition models may include, but are not limited to, neural networks, deep learning networks, etc. Further, and as discussed above, classification models may include, but are not limited to, a logistic regression model, a decision tree, a random forest, a gradient-boosted tree, a multilayer perceptron, a transformer-based language model (e.g., a BERT model), etc.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

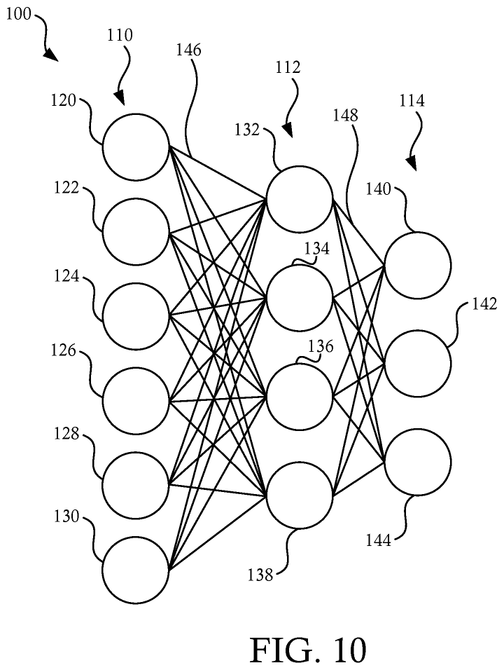

FIG. 10 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, x_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} = γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot f ( {\sum }_{i} {x}_{i}^{( n )} \cdot {w}_{i , j}^{( n )} )$$

if the (n+1)-th layer is the output layer 114, wherein f′ is the first derivative of the activation function, and γⱼ⁽ⁿ⁺¹⁾ is the comparison training value for the j-th node of the output layer 114.

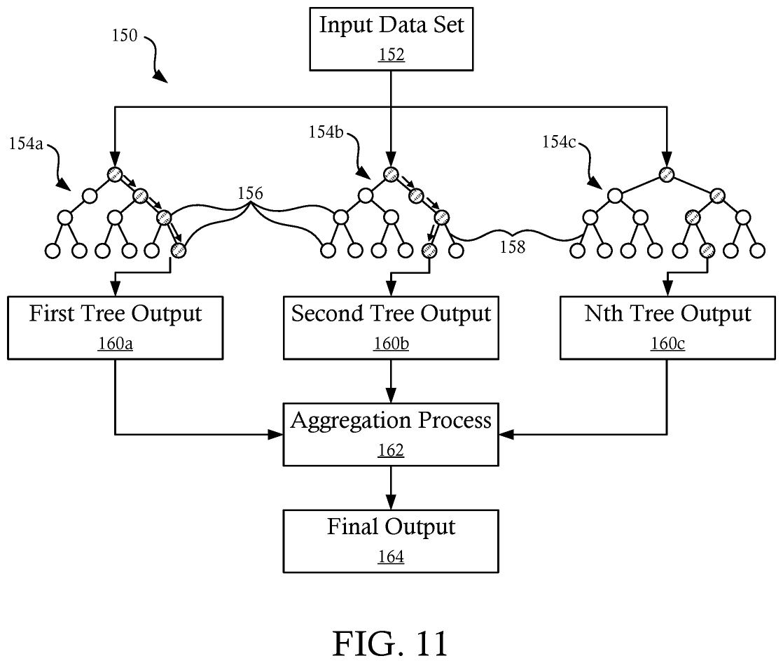

FIG. 11 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

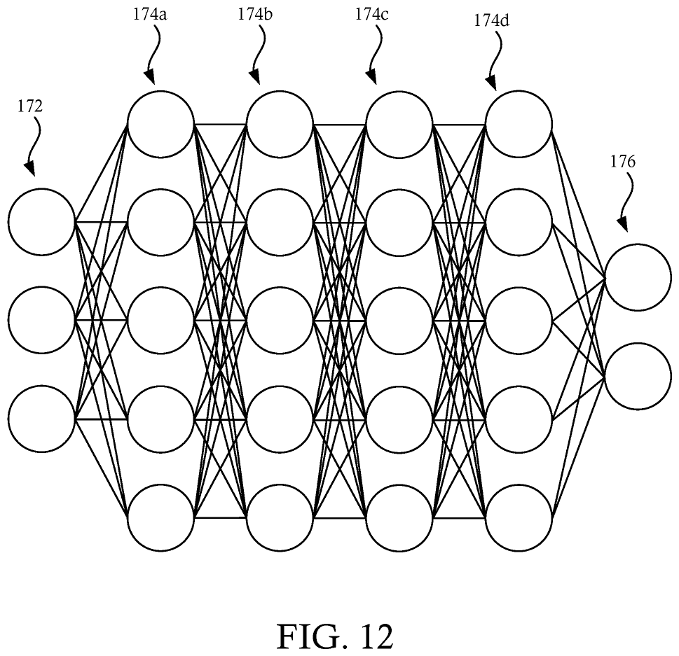

FIG. 12 illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + ⋯ + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

y=e^{β}e^{f(log x)}eΣᵢfᵢ^{d}(dᵢ)

where d represents one or more features of the independent variable x.

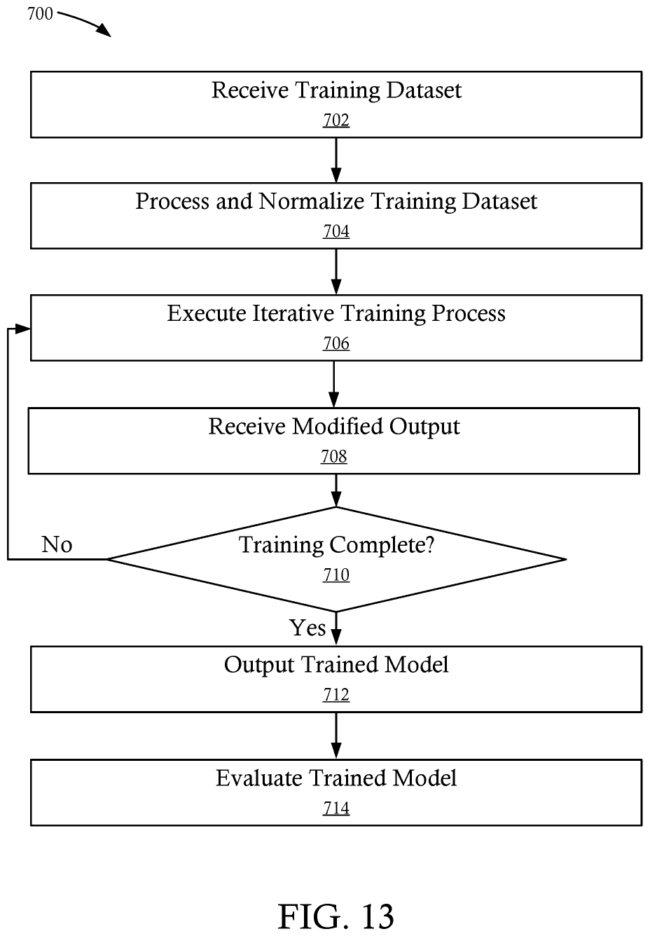

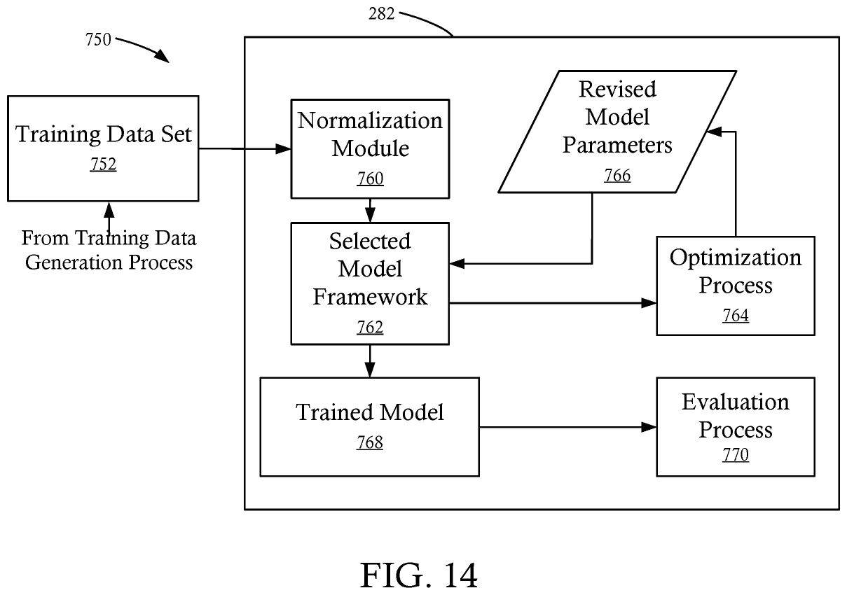

In some embodiments, one or more of the filtering submodules 260 can include and/or implement one or more trained models, such as a trained language model, a trained image recognition model, and/or a trained classification model. In some embodiments, one or more trained models can be generated using an iterative training process based on a training dataset. FIG. 13 illustrates a method 700 for generating a trained model, such as a trained optimization model, in accordance with some embodiments. FIG. 14 is a process flow 750 illustrating various steps of the method 700 of generating a trained model, in accordance with some embodiments. At step 702, a training dataset 752 is received by a system, such as a processing device 10. The training dataset 752 can include labeled and/or unlabeled data. For example, the training dataset 752 may include a set of non-compliant data records and/or portions of non-compliant data records. In some embodiments, the training dataset 752 may additionally include compliant data records and/or portions of compliant data records.

At optional step 704, the received training dataset 752 is processed and/or normalized by a normalization module 760. For example, in some embodiments, the training dataset 752 can be augmented by imputing or estimating missing values of one or more features. In some embodiments, processing of the received training dataset 752 includes outlier detection configured to remove data likely to skew training of a relevant model. In some embodiments, processing of the received training dataset 752 includes removing features that have limited value with respect to training of the relevant model, such as modifying the training dataset 752 for training of a language model, an image recognition model, and/or a classification model (e.g., removing image data when training a language model).

At step 706, an iterative training process is executed to train a selected model framework 762. The selected model framework 762 can include an untrained (e.g., base) machine learning model, such as a language model framework, an image recognition framework, a classification framework, etc. and/or a partially or previously trained model (e.g., a prior version of a trained model). The training process is configured to iteratively adjust parameters (e.g., hyperparameters) of the selected model framework 762 to minimize a cost value (e.g., an output of a cost function) for the selected model framework 762. In some embodiments, the cost value is related to identification of a non-compliant update/data record, misidentification of a non-compliant update/data record, and/or misidentification of a compliant update/data record.

The training process is an iterative process that generates set of revised model parameters 766 during each iteration. The set of revised model parameters 766 can be generated by applying an optimization process 764 to the cost function of the selected model framework 762. The optimization process 764 can be configured to reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained model 768, such as a trained language model, a trained image recognition model, a trained classification model, etc., is output and provided for use in a database update method 200, for example being implemented by one or more filtering submodules 260 as part of a multilayer monitoring process 300 as discussed above with respect to FIGS. 3-9. At optional step 712, a trained model 768 can be evaluated by an evaluation process 770. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

1. A system, comprising:
a processor; and
a non-transitory memory storing instructions that, when executed, cause the processor to:
receive a database update including at least one addition of or modification to a data record in a database, wherein the database update is determined by one or more data elements;
generate a compliance status by providing at least a portion of the database update to a multilayer monitoring process that implements at least a keyword similarity process and a trained classification model, wherein the keyword similarity process and the trained classification model are executed in series;
responsive to the compliance status indicating an approved database update, add or modify, based on the database update, the data record in the database; and
responsive to the compliance status indicating a rejected database update, remove the database update from a pending database update queue.

2. The system of claim 1, wherein the multilayer monitoring process implements the trained classification model in response to an output of the keyword similarity process.

3. The system of claim 1, wherein the multilayer monitoring process includes at least one of a text similarity process or an image recognition process.

4. The system of claim 3, wherein the at least one of the text similarity process or the image recognition process is implemented in parallel with the keyword similarity process.

5. The system of claim 1, wherein the keyword similarity process comprises a direct match process and a distance match process.

6. The system of claim 5, wherein the distance match process comprises a Jaro-Winkler distance based process.

7. The system of claim 1, wherein the trained classification model comprises at least one transformer-based language model layer.

8. The system of claim 7, wherein the trained classification model comprises a first set of transformer-based language model layers that classify a textual element in one of a plurality classes each having a corresponding label and a second set of transformer-based language model layers that receive the textual element and the corresponding label and output a binary classification.

9. The system of claim 1, wherein prior to generating the compliance status, the processor determines a difference between the database update and the data record in the database.

10. A computer-implemented method, comprising:
receiving a database update including at least one modification of a data record in a database, wherein the database update is determined by one or more data elements;
determining when the at least one modification corresponds to one of a predetermined set of data elements of the data record;
in response to determining the at least one modification corresponds to one of the predetermined set of data elements, generating a compliance status by a multilayer monitoring process that implements at least a keyword similarity process and a trained classification model based on at least the at least one modification, wherein the keyword similarity process and the trained classification model are executed in series;
in response to the compliance status indicating an approved database update, add or modify, based on the database update, the data record in the database; and
in response to the compliance status indicating a rejected database update, remove the database update from a pending database update queue.

11. The computer-implemented method of claim 10, wherein the multilayer monitoring process implements the trained classification model in response to an output of the keyword similarity process.

12. The computer-implemented method of claim 10, wherein the multilayer monitoring process includes at least one of a text similarity process or an image recognition process.

13. The computer-implemented method of claim 12, wherein the at least one of the text similarity process or the image recognition process is implemented in parallel with the keyword similarity process.

14. The computer-implemented method of claim 10, wherein the keyword similarity process comprises a direct match process and a distance match process.

15. The computer-implemented method of claim 14, wherein the distance match process comprises a Jaro-Winkler distance based process.

16. The computer-implemented method of claim 10, wherein the trained classification model comprises at least one transformer-based language model layer.

17. The computer-implemented method of claim 16, wherein the trained classification model comprises a first set of transformer-based language model layers that classify a textual element in one of a plurality classes each having a corresponding label and a second set of transformer-based language model layers that receive the textual element and the corresponding label and output a binary classification.

18. A non-transitory computer-readable medium having instructions stored thereon, wherein the instructions, when executed by at least one processor, cause at least one device to perform operations comprising:
receiving a database update including at least one addition of or modification to a data record in a database, wherein the database update is determined by one or more data elements;
implement a keyword similarity process that determines a similarity between at least one textual element of the database update and each of a set of predetermined terms;
in response to the keyword similarity process determining the similarity between the at least one textual element and each of the set of predetermined terms is below a predetermined threshold, implement a trained classification model that classifies the database update as one of an approved or rejected, wherein the keyword similarity process and the trained classification model are executed in series;
in response to the trained classification model classifying the database update as approved, add or modify, based on the database update, the data record in the database; and
in response to the trained classification model classifying the database update as rejected, remove the database update from a pending database update queue.

19. The non-transitory computer-readable medium of claim 18, wherein the keyword similarity process comprises a direct match process and a distance match process.

20. The non-transitory computer-readable medium of claim 19, wherein the distance match process comprises a Jaro-Winkler distance based process.
